(19) United States
(12) Patent Application Publication
(10) Pub. No.: US 2007/0064143 A1
(43) Pub. Date: Mar. 22, 2007

(54) Method and system for capturing a wide-field image and a region of interest thereof

(76) Inventors: Daniel Soler, La Tour D'Aigues (FR); Philippe Godefroy, Marseille (FR)

Correspondence Address: CLARK & BRODY, 1090 VERMONT AVENUE, NW, SUITE 250, WASHINGTON, DC, 20005, US

(21) Appl. No.: 10/552,349

(22) PCT Filed: Oct. 22, 2004
(86) PCT No.: PCT/FR04/02723

§ 371 Date: Aug. 11, 2006

Related U.S. Application Data
(60) Provisional application No. 60/532,750, filed on Dec. 23, 2003.

(30) Foreign Application Priority Data
Oct. 24, 2003 (FR) 0312469

(51) Int. Cl. G02B 13/16

(52) U.S. Cl. 348/335

(57) ABSTRACT

This system captures an image acquired by a simply connected wide-field optical system (1) providing a first optical channel, this image being captured by a first video camera. A sampling optical system inserted into this first channel captures on a second video camera a narrow field corresponding to a region of interest of the wide field.

The invention relates to a method and a system for capturing a simply connected wide-field image, and where applicable for displaying and processing the image.

In the present document, the expression “simply connected” is to be understood in the mathematical sense. In the context of the invention, it means that the wide field observed is connected (i.e. consists of one piece) and does not have any “holes”, unlike a peripheral field of view, for example, in which there is a loss of field around the axis of symmetry.

The invention is more particularly directed to a method and a system for capturing or viewing a region of interest of an image that has a much higher resolution than the remainder of the image, preferably using the same matrix sensor.

The invention finds non-limiting applications in image processing systems, surveillance and remote surveillance systems, observation systems on moving vehicles or robots and, more generally, in applications requiring a very high resolution.

This kind of method may be used in particular to explore a wide-field image covering an entire half-space by “sliding” the observed region of interest, and in particular by optically zooming onto or sensing on the region of interest.

Methods and systems for displaying and processing panoramic images and portions thereof are already known in the art.

The prior art methods are more particularly data processing or mathematical processing methods for correcting distortion or delaying the onset of the grainy appearance that occurs on enlarging a portion of a panoramic image obtained with a fish-eye lens.

U.S. Pat. No. 5,185,667 in particular discloses the use of mathematical functions to correct distortion in a region of interest of a panoramic image.

French patent No. 2 827 680 discloses a method of enlarging a panoramic image projected onto a rectangular image sensor and a fish-eye lens adapted to distort the image anamorphically.

Finally, U.S. Pat. No. 5,680,667 discloses a teleconference system in which an automatically selected portion of a panoramic image corresponding to the participant who is speaking at a given time is corrected electronically prior to transmission.

To summarize, the methods and systems referred to above process a panoramic image digitally to enlarge a region of interest thereof.

Those methods all have the drawback that the degree of resolution of the selected image portion is limited by the resolution of the fish-eye lens for acquiring the panoramic image.

Another prior art system, disclosed in US patent application No. 2002/0012059 (DRISCOLL), uses a fish-eye lens to duplicate the image plane.

The system includes a first matrix sensor placed in a first image plane and a second matrix sensor placed in the second image plane, the pixels of the first matrix sensor being smaller than those of the second matrix sensor.

The first matrix sensor is moved in translation or rotation in one of the two image planes to scan the wide field with higher resolution.

The person skilled in the art will realize that the increase in the resolution of the area of interest of the image in the above system is equal to the ratio of the size of the pixels of the two matrix sensors.

A system of the above type, in which the resolution is directly dependent on the resolution ratio of the two sensors, is unsuitable for use in many applications, and in particular:

in applications in the infrared range (3 micrometers (μm) to 5 μm and 8 μm to 12 μm), for which there are no sensors with dimensions enabling enlargement by a factor of 10, for example, and

in applications in the visible range with resolution factors greater than 10.

Another prior art system, described in US patent application No. 2003/0095338, uses mirrors of complex shape to capture a peripheral field and image it on one or more video cameras.

Unfortunately, such systems all have a field of view capture system that is blind over a portion of the field, ruling out obtaining a simply connected wide-field view.

The invention aims to alleviate the above drawbacks.

To this end, a first aspect of the invention provides a system for capturing an image acquired by a simply connected wide-field optical system consisting of an afocal lens with angular enlargement of less than 1 and supplying a wide-field first light beam. The system comprises:

means for selecting from the first beam a second light beam corresponding to a narrow field within the wide field and showing a region of interest of the image;

a first video camera including a lens adapted to capture the narrow-field second beam with a first resolution;

means for duplicating the wide-field first light beam to produce a duplicate first beam; and

a second video camera including a lens adapted to capture the whole of the duplicate first beam with a second resolution lower than the first resolution by a reduction coefficient defined by the ratio between the wide field and the narrow field.

The second video camera and the first video camera preferably have identical matrices of photosensitive elements.

Thus the capture system of the invention uses a purely optical technique to increase the resolution of the area of interest of the image, even when the photosensitive element matrices of both video cameras are identical.

Moreover, the system of the invention can capture the entire half-space.

The invention therefore makes it possible to observe a region of interest of a wide-field image with a resolution much higher than that available with prior art systems and methods.

In a first variant, the first video camera being mobile, the selection means include means for positioning the first video camera in a position such that it receives the second beam.

In a second variant, the first video camera being stationary, the selection means include deflection means for deflecting the second beam towards the first video camera.

Thus both the above variants capture a region of interest of a wide-field image with a high resolution without it being necessary to move the first video camera over the whole of the wide field. Assuming, for example, that the wide field corresponds to a half-space (180°) and that the reduction coefficient defined by the ratio between the wide field and the narrow field is equal to 10, it suffices to move the first video camera (or the deflection means) over an angle of 18° to cover the whole of the half-space with the first video camera.

A particularly fast capture system is therefore obtained.

When the capture system is onboard a vehicle or a robot, it is highly advantageous for the overall external size of the capture system to correspond to only the lens of the wide-field stationary optical system. This feature is particularly important if the system is installed in aircraft with severe aerodynamic constraints.

The first video camera preferably includes an optical zoom system for defining the angular magnitude of the region of interest.

In a preferred embodiment, the system of the invention further comprises means for duplicating the first beam to produce a duplicate first beam and a second video camera for capturing all of the duplicate first beam.

In a first variant of this preferred embodiment, the capture system of the invention comprises a station for viewing the image in the vicinity of control means of the selection means.

It is then possible to position the first video camera in the second beam corresponding to the region of interest with reference to the wide-field image as a whole and to control the optical zoom system from the viewing station.

Thus the observer is able to enlarge a portion of the panoramic image from the viewing station, for example by means of a lever or a joystick, the resolution of the region of interest being defined by the characteristics of the first video camera.

In a second variant of the preferred embodiment, the capture system of the invention includes means for processing the image adapted to detect a movement and/or a variation of luminous intensity in the image and to control the selection means accordingly.

This variant is particularly suitable for surveillance and intruder detection applications.

In a variant that is primarily for military use, the optical system and the first video camera are adapted to capture first and second infrared light beams.

The invention also provides a system for capturing an image covering a 360° space, the system comprising two capture systems as briefly defined above arranged back-to-back, the optical systems of the capture systems being adapted to cover a half-space.

Since the advantages of the above capture method and the above system for capturing an image covering a 360° space are exactly the same as those of the above-described capture system, they are not repeated here.

Other aspects and advantages of the present invention become more clearly apparent on reading the following description of one particular embodiment of the invention given by way of non-limiting example only and with reference to the appended drawings, in which:

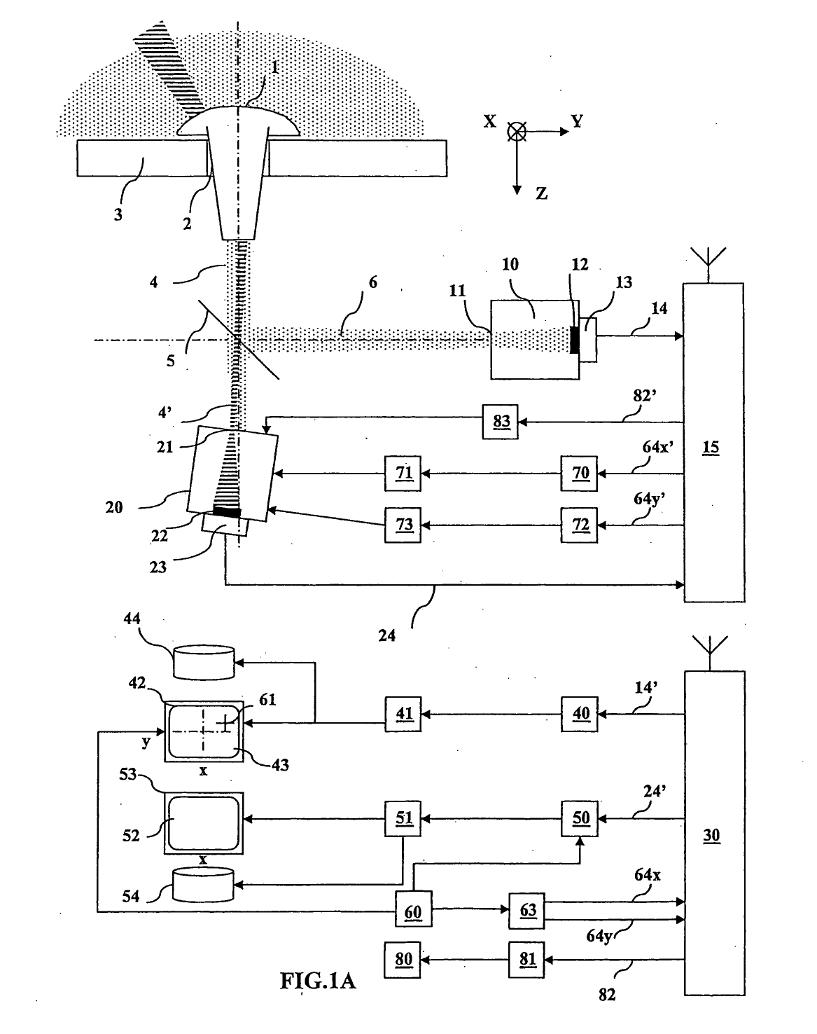

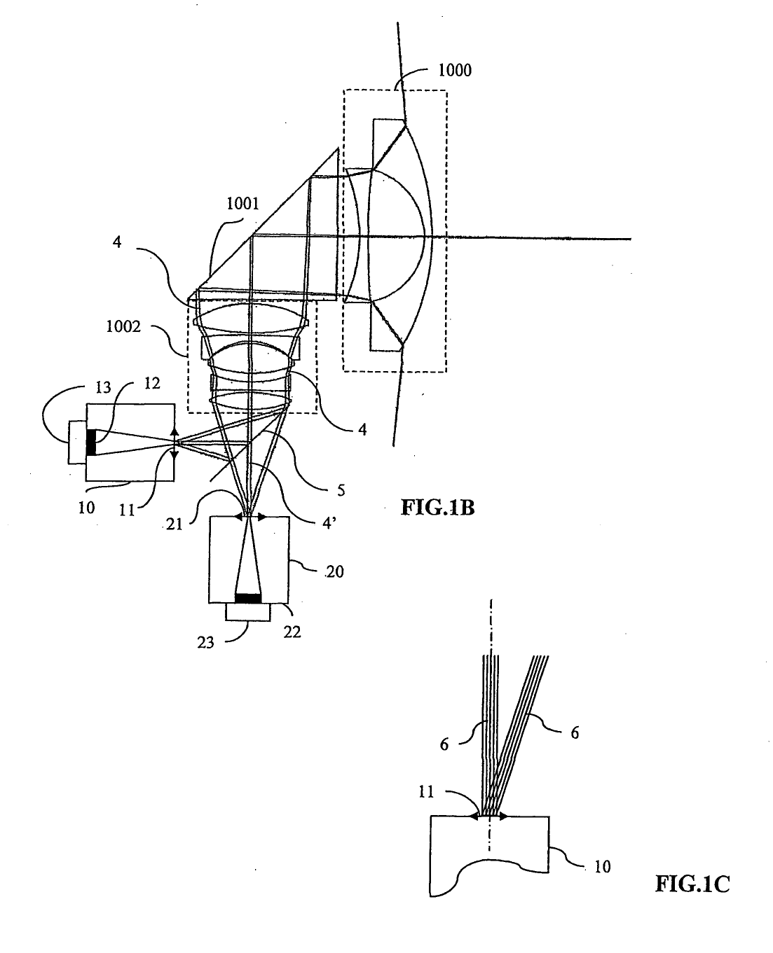

FIG. 1A shows a preferred embodiment of a capture system of the invention;

FIGS. 1B and 1C show details of the FIG. 1A capture system;

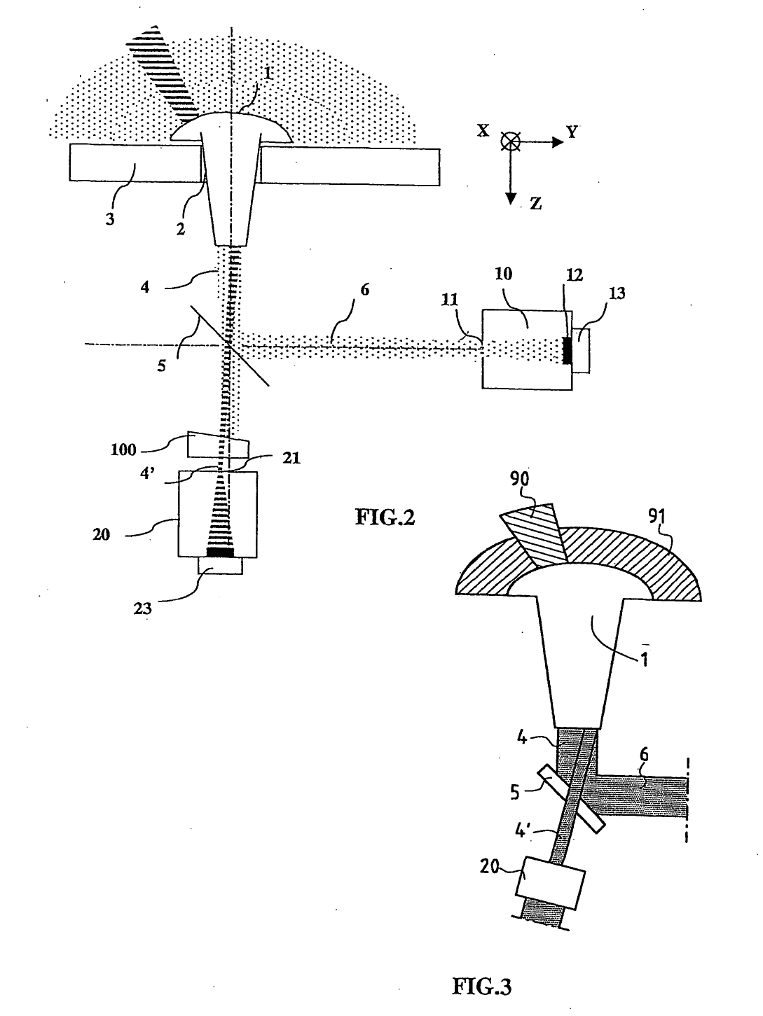

FIG. 2 shows another embodiment of a capture system of the invention;

FIG. 3 shows to a larger scale the spaces observed by each of the video cameras of the embodiment of the system shown in FIGS. 1A to 2;

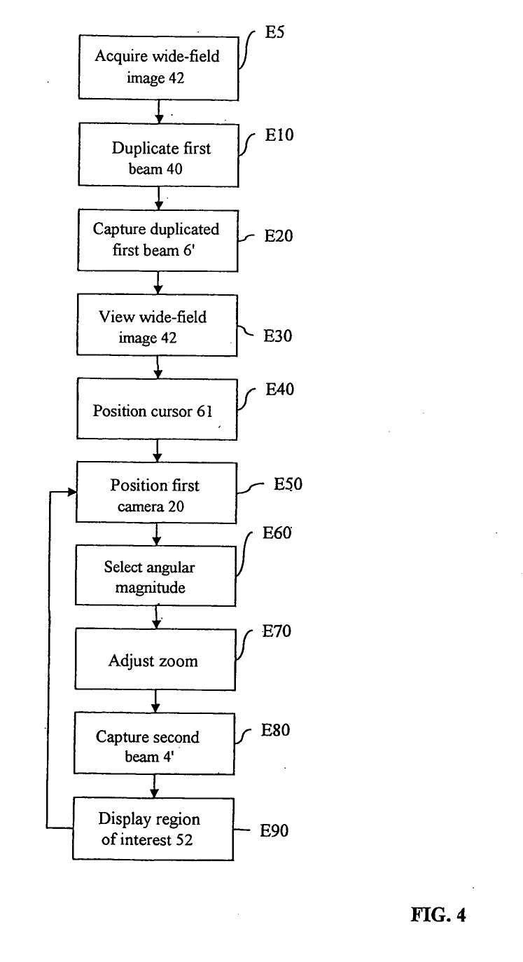

FIG. 4 shows main steps E5 to E90 of a preferred embodiment of a capture method of the invention;

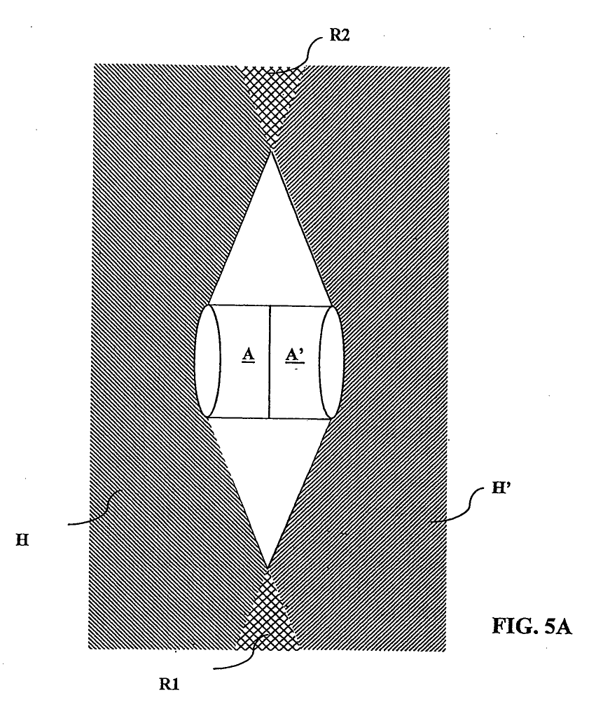

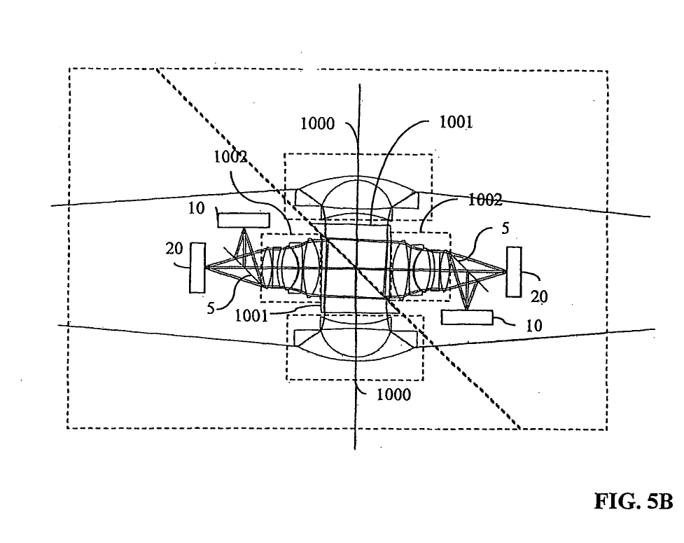

FIG. 5A shows a preferred embodiment of a capture system of the invention covering a 360° space; and

FIG. 5B shows details of the FIG. 5A capture system.

### The preferred embodiment described below with reference to FIGS. 1A to 1C in particular uses an afocal dioptric optical system 1.

The afocal dioptric optical system is shown in detail in FIG. 1B.

It consists primarily of three successive optical units 1000, 1001 and 1002.

The optical unit 1000 captures light rays from the simply connected optical field in front of it.

A prism 1001 (which may be replaced by a mirror) deflects the rays, if necessary, as a function of constraints on the overall size and mechanical layout of the system.

The rear unit 1002 provides optical magnification at the exit from the afocal optical system.

FIG. 1C shows in detail the shape of the light beams 6 at the exit of the afocal system 1 and at the entry of the lens 11 of the video camera 10.

The optical beam 4′ at the exit of the afocal system 1 and at the entry of the lens 21 of the video camera 20 are the same shape.

The wide-field afocal dioptric optical system 1 having an axis Z is known in the art and is mounted in an opening 2 in a wall 3.

The wall 3 may be the casing of an imaging system, the skin of an aircraft fuselage or the ceiling of premises under surveillance.

The afocal wide-field optical system 1 of the invention has angular magnification of less than 1.

This optical system 1 produces a first light beam 4 coaxial with the axis Z. A beam duplicator 5 on the path of the first light beam 4 reflects the first beam 4 in a direction Y that is preferably perpendicular to the axis Z to generate a duplicate first beam 6 with axis Z.

The lens 21 of a mobile first digital video camera 20 on the path of the first light beam 4 with axis X and on the downstream side of the duplicator 5 captures only a narrow second light beam 4′ that is part of the first light beam 4.

This video camera 20 is equipped with a matrix 22 of photosensitive charge-coupled devices (CCD) and means 23 for generating and delivering a stream of first electrical signals 24.

A transceiver 15 equipped with a multiplexing system then sends the first signals 24 by radio, infrared or cable means to an observation station described hereinafter.

The lens 11 of a stationary second digital video camera 10 coaxial with the axis Y captures the whole of the duplicate first beam 6.

The second video camera 10 is also equipped with a matrix 12 of photosensitive charge-coupled devices and means 13 for generating and delivering a stream of second electrical signals 14 representing the panoramic image captured by the second video camera 10.

The transceiver 15 sends these second electrical signals 14 to the observation station.

Apart from their lenses 11 and 21, the two video cameras 10 and 20 may be identical. In particular, the number of pixels defined by the photosensitive device matrices 21 and 22 may be identical. The images or photographs of identical size obtained from the two streams of signals 14 and 24 then have the same resolution.

The streams of signals 14 and 24 sent by the transceiver 15 are received in the observation station by the receiver of a second transceiver 30 which is also equipped with a multiplexing system.

Streams of second signals 14′ received by the second transceiver 30 and equivalent to the streams of second signals 14 are processed by an image distortion and information processing electronic system 40 which supplies to a memory 41 data showing a wide-field image 42 captured by the second video camera 10.

The wide-field image 42 is displayed on a screen 43 and the data of the image 42 may be stored in an archive on a storage medium 44 for later viewing.

In the same way, streams of first signals 24′ received by the second transceiver 30 and equivalent to the streams of first signals 24 are processed by a second image distortion and information processing electronic system 50 that supplies to a second memory 51 data showing a region of interest 52 captured by the first video camera 20.

The region of interest 52 is displayed on a second screen 53 and the data of the region of interest 52 may advantageously be stored on a second storage medium 54 for later viewing.

The electronic systems 40 and 50 may advantageously be replaced by a commercial microcomputer running software for processing the image distortion inherent to wide-angle lenses, such as those known in the art.

Without departing from the scope of the invention, the region of interest 52 of the wide-field image 42 may also be embedded in the wide-field image 42 and displayed on the same screen as the wide-field image.

The observation station also includes a browser 60 for browsing the wide-field image 42.

For example, the browser 60 may include a joystick for positioning a cursor 61 in the wide-view image 42 displayed on the screen 43.

The position of the cursor 61 defines the angular coordinates θx, θy of the region of interest 52 of the wide-field image 42 filmed by the first video camera 20 that the observer wishes to display on the second screen 53.

The coordinates x and y defined by the browser 60 are preferably delivered to the second electronic system 50 so that it can correctly process the distortion of the image captured by the first video camera 20.

The angular coordinates θx, θy are also supplied to a system 63 that delivers to the second transceiver a first train of signals 64x showing the value θx and a second stream of signals 64y showing the value θy.

The second transceiver 30 sends the signals 64x and 64y to the transceiver 15 of the imaging system.

The first stream of signals 64x′ received by the transceiver 15 and equivalent to the first stream of signals 64x is delivered to a control unit 70 of a first electric motor 71 for pivoting the first video camera 20 about the axis X to capture the narrow field of view corresponding to the second beam 4′.

Similarly, the second stream of signals 64y′ received by the transceiver 15 and equivalent to the second stream of signals 64y is delivered to a control unit 72 of a second electric motor 73 for pivoting the first video camera 20 about the axis Y in the first light beam 4.

The second light beam 4′ captured by the first video camera 20 is selected by pivoting the first video camera 20 about the axes X and Y.

The movements of the first video camera 20 obviously correspond to angular coordinates in the wide-field image 42 displayed on the screen 43, of course.

Note that the angular coordinates θx and θy of the wide-field image 42 correspond to an observed field viewing angle close to 180° even though the angular movements θx and θy of the first video camera 20 in the first light beam 4 are very small.

This enables the first video camera 20 to be moved very quickly to the position (θx, θy) selected by the observer and to capture the second light beam 4′ corresponding to the region of interest 52 of the wide-field image 42 that will produce the high-resolution region of interest 52.

As shown in FIG. 1, the browser 60 is advantageously associated with a system for displaying the angular magnitude 80 of the region of interest 52 to be displayed on the screen 53.

The corresponding information is delivered to an electronic system 81 that generates corresponding signals 82 sent by the second transceiver 30 to the first transceiver 15 of the imaging system.

The corresponding received signals 82′ are delivered to a control unit 83 of an optical zoom system of the first video camera 20.

The region of interest 52 displayed on the second screen 53 will therefore enlarged to a greater or lesser extent as a function of the adjustment of the optical zoom system, preserving the same resolution.

It is therefore possible to view details of the wide-field image 42 with great precision.

In a different embodiment, the capture system includes image processing means (for example software means) adapted to detect a movement and/or a variation of the luminous intensity in the wide-field image 42 and to command the selection means accordingly.

Image processing means of this kind are known to the person skilled in the art and are not described here. They are adapted in particular to perform conventional segmentation and shape recognition operations.

FIG. 2 shows a different embodiment of a capture system of the invention.

FIG. 2 does not show the observation system of this embodiment, which is identical to that described with reference to FIGS. 1A to 1C.

In this embodiment, the first video camera 20 is stationary and the second beam 4′ is deflected towards the first video camera 20 by a prism 100 rotatable about the axis Y.

In other embodiments that are not shown here, the prism 100 may be replaced by other deflection means and in particular by a mirror or any other diffraction system known to the person skilled in the art.

FIG. 3 shows the narrow field of view 90 that produces the second light beam 4′ that is captured by the first video camera 20 and the wide field of view 91 that is captured by the second video camera 10.

FIG. 4 shows main steps E5 to E90 of a preferred embodiment of a processing method of the invention.

During the first step E5, a wide-field image 42 is acquired with a wide-field optical system 1 providing a first light beam 4.

This acquisition step E5 is followed by the step E10 during which the first light beam 4 is duplicated.

This duplication may be obtained using a duplicator 5 as described briefly with reference to FIG. 1, for example.

The duplication step E10 is followed by the step E20 during which the whole of the duplicate first beam 6 is captured, for example by the second video camera 10 described above.

In the present embodiment, the step E20 of capturing the duplicate first beam 6 is followed by the step E30 of viewing the wide-field image 42 obtained from the duplicate first beam 6 by the second video camera 10 on a viewing station, for example on a screen 43.

This viewing step E30 is followed by steps E40 to E70 of selecting a second light beam 4′ from the first light beam 4.

To be more precise, during the step E40, a cursor 61 is positioned in the wide-field image 42 displayed on the screen 43.

This cursor may be moved by means of a joystick, for example.

Be this as it may, the position of the cursor 61 defines angular coordinates θx, θy of a region of interest 52 of the wide-field image 42 that the observer can view on a second screen 53, for example.

The step E40 of positioning the cursor 61 is followed by the step E50 of positioning the first video camera 20 so that it captures a second beam 4′ corresponding to the region of interest 52 selected during the preceding step.

The step E50 of positioning the first video camera 20 is followed by the step E60 of selecting, from the viewing station, the angular magnitude of the region of interest 52 to be displayed on the screen 53.

The step E60 of selecting this angular magnitude is followed by the step E70 during which the optical zoom system of the first video camera 20 is adjusted as a function thereof.

The step E70 of adjusting the optical zoom system is followed by the step E80 during which the second beam 4′ corresponding to the position and the angular magnitude of the region of interest 52 is captured.

The step E80 of capturing the second beam 4′ is followed by the step E90 during which the region of interest 52 is displayed on the screen 53, for example, or embedded in the panoramic image 42 displayed on the screen 43.

The step E90 of displaying the region of interest 52 is followed by the step E40 of positioning the cursor 61 described above.

In another embodiment, the step E20 of capturing the duplicate first beam is followed by a step of processing the wide-field image 42 to detect a movement or a variation of luminous intensity therein.

This image processing step therefore determines the angular coordinates θx, θy of a region of interest automatically, rather than the coordinates being selected by means of the cursor 61 as described above.

In a further embodiment, instead of moving the first video camera 20 (step E50), deflection means are pivoted as a function of the angular coordinates θx, θy to deflect the second beam 4′ towards the first video camera 20.

FIG. 5A shows a preferred embodiment of a capture system of the invention covering a 360° space and FIG. 5B shows details thereof.

The capture system comprises two capture systems A and A′ as described above with reference to FIGS. 1A to FIG. 2 arranged back-to-back.

In this embodiment, the optical systems of the two capture systems A and A′ are adapted to cover more than a half-space, as shown by the cross-hatched portions H and H′, respectively.

The person skilled in the art will readily understand that the cross-hatched portions R1 and R2 are overlap regions captured by both systems A and A′.

1. A system for capturing an image (42) acquired by a simply connected wide-field optical system (1) consisting of an afocal lens with angular enlargement of less than 1 and supplying a wide-field first light beam (4), the system comprising:
means for selecting from said first beam (4) a second light beam (4′) corresponding to a narrow field within said wide field and showing a region of interest (52) of said image (42);
a first video camera (20) including a lens (21) adapted to capture said narrow-field second beam (4′) with a first resolution;
means (5) for duplicating said wide-field first light beam (4) to produce a duplicate first beam (6); and
a second video camera (10) including a lens (11) adapted to capture the whole of said duplicate first beam (6) with a second resolution lower than said first resolution by a reduction coefficient defined by the ratio between said wide field and said narrow field,
said second video camera (10) and said first video camera (20) preferably having identical photosensitive element matrices (21, 22).

2. A capture system according to claim 1, characterized in that, said first video camera (20) being mobile, said selection means include means (60, 61, 71, 73) for positioning said first video camera (20) in a position (θx, θy) such that it receives said second beam (4′).

3. A capture system according to claim 1, characterized in that, said first video camera (20) being stationary, said selection means include deflection means for deflecting said second beam (4′) towards said first video camera (20).

4. A capture system according to claim 3, characterized in that said deflection means comprise a prism, a mirror or any type of diffraction system rotatable in said first beam (4).

5. A capture system according to claim 1, characterized in that the first video camera (20) includes an optical zoom system for defining the angular magnitude of said region of interest (52).

6. A capture system according to claim 1, characterized in that it further includes a station (43) for viewing said image (42) in the vicinity of control means (83) of said selection means.

7. A capture system according to claim 1, characterized in that it includes means for processing said image (42) adapted to detect a movement and/or a variation of luminous intensity in said image (42) and to command said selection means accordingly.

8. A capture system according to claim 1, characterized in that said optical system (1) and said first video camera (10) are adapted to capture first and second infrared light beams (4, 4′).

9. A system for capturing an image covering a 360° space, characterized in that it comprises two capture systems (A, A′) according to claim 1 arranged back-to-back, the optical systems of the capture systems (A, A′) being adapted to cover at least a half-space.

10. A system for capturing an image covering a 360° space, characterized in that it comprises two capture systems (A, A′) according to claim 2 arranged back-to-back, the optical systems of the capture systems (A, A′) being adapted to cover at least a half-space.

11. A system for capturing an image covering a 360° space, characterized in that it comprises two capture systems (A, A′) according to claim 3 arranged back-to-back, the optical systems of the capture systems (A, A′) being adapted to cover at least a half-space.

12. A system for capturing an image covering a 360° space, characterized in that it comprises two capture systems (A, A′) according to claim 4 arranged back-to-back, the optical systems of the capture systems (A, A′) being adapted to cover at least a half-space.

13. A system for capturing an image covering a 360° space, characterized in that it comprises two capture systems (A, A′) according to claim 5 arranged back-to-back, the optical systems of the capture systems (A, A′) being adapted to cover at least a half-space.

14. A system for capturing an image covering a 360° space, characterized in that it comprises two capture systems (A, A′) according to claim 6 arranged back-to-back, the optical systems of the capture systems (A, A′) being adapted to cover at least a half-space.

15. A system for capturing an image covering a 360° space, characterized in that it comprises two capture systems (A, A′) according to claim 7 arranged back-to-back, the optical systems of the capture systems (A, A′) being adapted to cover at least a half-space.

16. A system for capturing an image covering a 360° space, characterized in that it comprises two capture systems (A, A′) according to claim 8 arranged back-to-back, the optical systems of the capture systems (A, A′) being adapted to cover at least a half-space.
